(19) United States
(12) Patent Application Publication
(10) Pub. No.: US 2022/0343636 A1
(43) Pub. Date: Oct. 27, 2022

(54) METHOD AND APPARATUS FOR ESTABLISHING IMAGE RECOGNITION MODEL, DEVICE, AND STORAGE MEDIUM

(71) Applicant: Beijing Baidu Netcom Science Technology Co., Ltd., Beijing (CN)

(72) Inventor: Wanping ZHANG, Beijing (CN)

(21) Appl. No.: 17/858,682

(22) Filed: Jul. 6, 2022

(30) Foreign Application Priority Data
Jul. 28, 2021 (CN) 202110856547.1

(51) Int. Cl. G06V 10/80; G06V 10/77; G06V 10/74; G06T 3/40; G06T 5/00

(52) U.S. Cl. CPC G06V 10/80; G06V 10/7715; G06V 10/761; G06T 3/40; G06T 5/001; G06T 2207/20016

(57) ABSTRACT

A method and apparatus for establishing an image recognition model, a device, and a storage medium are provided. The method includes: acquiring an inputted image set; performing co-training on an initial super-resolution model and an initial recognition model using the inputted image set, to obtain a trained super-resolution model and a trained recognition model; and combining the trained super-resolution model and the trained recognition model in a cascaded manner to obtain the image recognition model.

### CROSS-REFERENCE TO RELATED APPLICATIONS

The present application claims the priority of Chinese Patent Application No. 202110856547.1, titled “METHOD AND APPARATUS FOR ESTABLISHING IMAGE RECOGNITION MODEL, DEVICE, AND STORAGE MEDIUM”, filed on Jul. 28, 2021, the content of which is incorporated herein by reference in its entirety.

### TECHNICAL FIELD

The present disclosure relates to the technical field of artificial intelligence, particularly relates to the technical fields of computer vision and deep learning, more particularly relates to a method and apparatus for establishing an image recognition model, a device, and a storage medium, and may be applied to a scenario such as face recognition.

### BACKGROUND

As one of the earliest and most widely implemented technologies among computer vision technologies, face recognition particularly has been widely applied in the fields of security and mobile payment. With the wide application of deep learning in face recognition technologies, an accuracy of face recognition based on deep learning has been greatly improved.

However, in a more general unconstrained natural scenario, after a camera captures a video stream, the captured face image will often have a poor quality such as a blurry and small face area, thereby resulting in a low pass rate in recognition or a high mis-recognition rate.

### SUMMARY

The present disclosure provides a method and apparatus for establishing an image recognition model, a device, and a storage medium.

Some embodiments provide a method for establishing an image recognition model, including: acquiring an inputted image set; performing co-training on an initial super-resolution model and an initial recognition model using the inputted image set, to obtain a trained super-resolution model and a trained recognition model; and combining the trained super-resolution model and the trained recognition model in a cascaded manner to obtain the image recognition model.

Some embodiments provide an image recognition method, including: acquiring a to-be-recognized image; and inputting the to-be-recognized image into an image recognition model to output a recognition result corresponding to the to-be-recognized image, where the image recognition model is obtained using the above method for establishing an image recognition model.

Some embodiments provide an apparatus for establishing an image recognition model, including: a first acquiring module configured to acquire an inputted image set; a training module configured to perform co-training on an initial super-resolution model and an initial recognition model using the inputted image set, to obtain a trained super-resolution model and a trained recognition model; and a combining module configured to combine the trained super-resolution model and the trained recognition model in a cascaded manner to obtain the image recognition model.

Some embodiments provide an image recognition apparatus, including: a second acquiring module configured to acquire a to-be-recognized image; and an output module configured to input the to-be-recognized image into an image recognition model to output a recognition result corresponding to the to-be-recognized image, where the image recognition model is obtained using the above method for establishing an image recognition model.

Some embodiments provide an electronic device, including: at least one processor; and a memory communicatively connected to the at least one processor; where the memory stores instructions executable by the at least one processor, and the instructions are executed by the at least one processor, such that the at least one processor can execute the above method for establishing an image recognition model or the above image recognition method.

Some embodiments provide a non-transitory computer readable storage medium storing computer instructions, where the computer instructions are used for causing a computer to execute the above method for establishing an image recognition model or the above image recognition method.

Some embodiments provide a computer program product, including a computer program, where the computer program, when executed by a processor, implements the above method for establishing an image recognition model or the above image recognition method.

It should be understood that contents described in the SUMMARY are neither intended to identify key or important features of embodiments of the present disclosure, nor intended to limit the scope of the present disclosure. Other features of the present disclosure will become readily understood with reference to the following description.

### BRIEF DESCRIPTION OF THE DRAWINGS

The accompanying drawings are used for better understanding of the present solution, and do not impose any limitation on the present disclosure. In the figures:

FIG. 1 is a diagram of an exemplary system architecture in which embodiments of the present disclosure may be implemented;

FIG. 2 is a flowchart of a method for establishing an image recognition model according to an embodiment of the present disclosure;

FIG. 3 is a schematic diagram of an application scenario of the method for establishing an image recognition model according to the present disclosure;

FIG. 4 is a flowchart of the method for establishing an image recognition model according to another embodiment of the present disclosure;

FIG. 5 is a flowchart of the method for establishing an image recognition model according to still another embodiment of the present disclosure;

FIG. 6 is a flowchart of an image recognition method according to an embodiment of the present disclosure;

FIG. 7 is a schematic structural diagram of an apparatus for establishing an image recognition model according to an embodiment of the present disclosure;

FIG. 8 is a schematic structural diagram of an image recognition apparatus according to an embodiment of the present disclosure; and

FIG. 9 is a block diagram of an electronic device configured to implement a method for establishing an image recognition model of embodiments of the present disclosure.

### DETAILED DESCRIPTION OF EMBODIMENTS

Example embodiments of the present disclosure are described below with reference to the accompanying drawings, including various details of the embodiments of the present disclosure to contribute to understanding, which should be considered merely as examples. Therefore, those of ordinary skills in the art should realize that various alterations and modifications may be made to the embodiments described here without departing from the scope and spirit of the present disclosure. Similarly, for clearness and conciseness, descriptions of well-known functions and structures are omitted in the following description.

It should be noted that the embodiments in the present disclosure and the features in the embodiments may be combined with each other on a non-conflict basis. The present disclosure will be described in detail below with reference to the accompanying drawings and in combination with the embodiments.

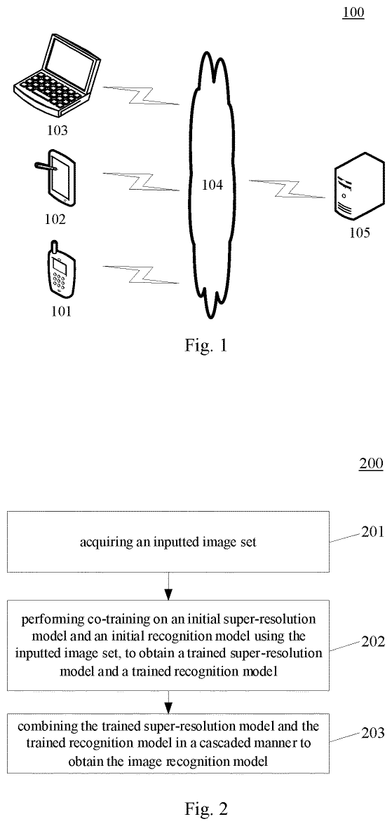

FIG. 1 shows an example system architecture 100 in which a method for establishing an image recognition model or an apparatus for establishing an image recognition model of embodiments of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, for example, to receive or send information. The terminal devices 101, 102, and 103 may be provided with various client applications.

The terminal devices 101, 102, and 103 may be hardware, or may be software. When the terminal devices 101, 102, and 103 are hardware, the terminal devices may be various electronic devices, including but not limited to a smart phone, a tablet computer, a laptop portable computer, a desktop computer, and the like. When the terminal devices 101, 102, and 103 are software, the terminal devices may be installed in the above electronic devices, or may be implemented as a plurality of software programs or software modules, or may be implemented as a single software program or software module. This is not specifically limited here.

The server 105 may provide various services. For example, the server 105 may analyze and process an inputted image set acquired from the terminal devices 101, 102, and 103, and generate a processing result (e.g., an image recognition model).

It should be noted that the server 105 may be hardware, or may be software. When the server 105 is hardware, the server may be implemented as a distributed server cluster composed of a plurality of servers, or may be implemented as a single server. When the server 105 is software, the server may be implemented as a plurality of software programs or software modules (e.g., software programs or software modules for providing distributed services), or may be implemented as a single software program or software module. This is not specifically limited here.

It should be noted that the method for establishing an image recognition model provided in embodiments of the present disclosure is generally executed by the server 105.

Accordingly, the apparatus for establishing an image recognition model is generally provided in the server 105.

It should be understood that the numbers of terminal devices, networks, and servers in FIG. 1 are merely illustrative. Any number of terminal devices, networks, and servers may be provided based on actual requirements.

Further referring to FIG. 2, a process 200 of a method for establishing an image recognition model according to an embodiment of the present disclosure is shown. The method for establishing an image recognition model includes the following steps:

Step 201: acquiring an inputted image set.

In the present embodiment, an executing body (e.g., the server 105 shown in FIG. 1) of the method for establishing an image recognition model may acquire the inputted image set, where the inputted image set may include at least one inputted image.

It should be noted that the at least one inputted image in the inputted image set may be a plurality of images each including a face pre-collected by various approaches. For example, the inputted image set may be a set including a plurality of images acquired from an existing image library, and for another example, the inputted image set may also be a set including a plurality of images collected in real time by an image sensor (such as a camera sensor) in an actual application scenario. This is not specifically limited in the present disclosure.

Step 202: performing co-training on an initial super-resolution model and an initial recognition model using the inputted image set, to obtain a trained super-resolution model and a trained recognition model.

In the present embodiment, the executing body may perform co-training on the initial super-resolution model and the initial recognition model using the inputted image set acquired in step 201, to obtain the trained super-resolution model and the trained recognition model.

Here, the initial super-resolution model and the initial recognition model may be predetermined. For example, the initial super-resolution model may be a model such as a SRCNN (Super-Resolution Convolutional Neural Network), a FSRCNN (Fast Super-Resolution Convolutional Neural Network), or a SRGAN (Super-Resolution Generative Adversarial Network); and the initial recognition model may be, e.g., an existing classification and recognition model of ResNet (Residual Network) series, or a model designed based on actual requirements.

The executing body may perform co-training on the initial super-resolution model and the initial recognition model using the inputted image set acquired in step 201, to adjust a parameter of the initial super-resolution model and a parameter of the initial recognition model based on the inputted image set, and stop training when conditions for stopping the co-training are met, thereby obtaining the trained super-resolution model and the trained recognition model. The conditions for stopping the co-training may include a preset number of training times, or a circumstance in which a value of a loss function no longer decreases, or a circumstance in which a certain accuracy threshold is set and the training is stopped when the preset threshold is reached.

Step 203: combining the trained super-resolution model and the trained recognition model in a cascaded manner to obtain the image recognition model.

In the present embodiment, the executing body may combine the trained super-resolution model and the trained recognition model obtained in step 202 in the cascaded manner to obtain the image recognition model. In this step, the trained super-resolution model is placed before the recognition model, thereby adding more information to the recognition model, and achieving a better effect.

In the method for establishing an image recognition model provided in the embodiment of the present disclosure, first an inputted image set is acquired; then co-training is performed on an initial super-resolution model and an initial recognition model using the inputted image set, to obtain a trained super-resolution model and a trained recognition model; and finally the trained super-resolution model and the trained recognition model is combined in a cascaded manner to obtain the image recognition model. The method for establishing an image recognition model in the present embodiment performs co-training on the initial super-resolution model and the initial recognition model, thereby alleviating an impact of images with different resolutions on a classification task, improving a robustness of the image recognition model on low-quality data, and then improving a recognition accuracy of the image recognition model.

In the technical solution of the present disclosure, the acquisition, storage, and application of personal information of a user involved are in conformity with relevant laws and regulations, and do not violate public order and good customs.

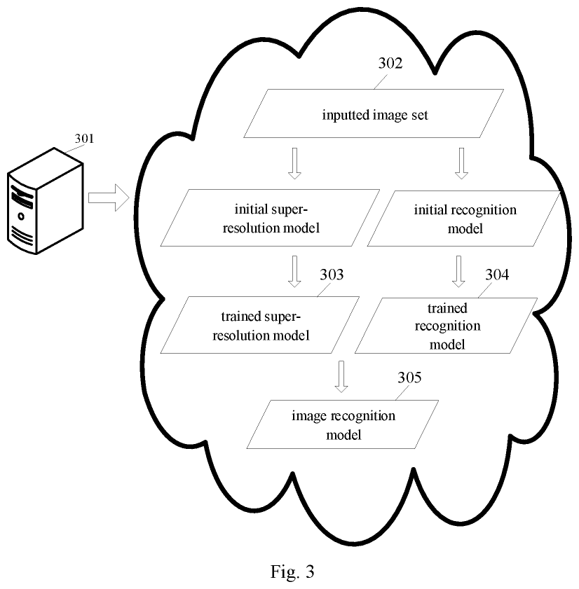

Further referring to FIG. 3, FIG. 3 is a schematic diagram of an application scenario of the method for establishing an image recognition model according to the present disclosure. In the application scenario of FIG. 3, first, an executing body 301 will acquire an inputted image set 302. Then, the executing body 301 will perform co-training on an initial super-resolution model and an initial recognition model using the inputted image set 302, to obtain a trained super-resolution model 303 and a trained recognition model 304. Finally, the executing body 301 will combine the trained super-resolution model 303 and the trained recognition model 304 in a cascaded manner to obtain the image recognition model 305.

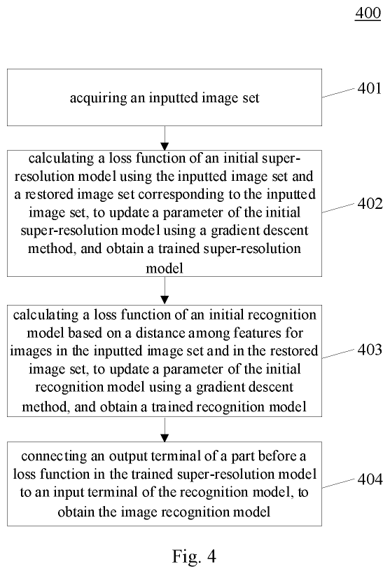

Further referring to FIG. 4, FIG. 4 shows a process 400 of the method for establishing an image recognition model according to another embodiment of the present disclosure. The method for establishing an image recognition model includes the following steps.

Step 401: acquiring an inputted image set.

Step 401 is substantially consistent with step 201 in the above embodiments, and the above description of step 201 may be referred to for specific implementations of this step. The description will not be repeated here.

Step 402: calculating a loss function of an initial super-resolution model using the inputted image set and a restored image set corresponding to the inputted image set, to update a parameter of the initial super-resolution model using a gradient descent method, and obtain a trained super-resolution model.

In the present embodiment, an executing body (e.g., the server 105 shown in FIG. 1) of the method for establishing an image recognition model may acquire the inputted image set, and then determine a restored image corresponding to each image in the inputted image set, thereby obtaining the restored image set corresponding to the inputted image set.

Then, the executing body may calculate the loss function of the initial super-resolution model using an inputted image in the inputted image set and a corresponding restored image in the restored image set, and use a gradient descent method to obtain a solution through iteration step by step, thereby obtaining a minimized loss function and a model parameter value.

Finally, the executing body may update the parameter of the initial super-resolution model based on the obtained model parameter value, thereby obtaining the trained super-resolution model, and improving the result quality.

Step 403: calculating a loss function of an initial recognition model based on a distance among features for images in the inputted image set and in the restored image set, to update a parameter of the initial recognition model using a gradient descent method, and obtain a trained recognition model.

In the present embodiment, the executing body may calculate the loss function of the initial recognition model based on the distance among features for images in the inputted image set and in the restored image set. For example, the executing body may combine the images in the inputted image set and the images in the restored image set, thereby obtaining a final image set, then calculating a distance among features for images in the obtained image set, and calculating the loss function of the initial recognition model based on the distance.

Then, the executing body uses the gradient descent method to obtain a solution through iteration step by step, thereby obtaining the minimized loss function and the model parameter value, and then update the parameter of the initial recognition model using the obtained model parameter value, thereby obtaining the trained recognition model, and improving the classification accuracy of the recognition model.

In some optional implementations of the present embodiment, the gradient descent method is a stochastic gradient descent method. The stochastic gradient descent method can be used to more quickly obtain the minimized loss function and the model parameter value, and improve the model training efficiency.

Step 404: connecting an output terminal of a part before a loss function in the trained super-resolution model to an input terminal of the recognition model, to obtain the image recognition model.

In the present embodiment, the executing body may connect the output terminal of the part before the loss function in the trained super-resolution model to the input terminal of the recognition model, thereby obtaining the image recognition model. The trained super-resolution model is placed before the recognition model, thereby adding more information to the recognition model, and achieving a better effect.

As can be seen from FIG. 4, compared with the corresponding embodiment of FIG. 2, the method for establishing an image recognition model in the present embodiment highlights the step of training the initial super-resolution model and the initial recognition model using the inputted image set, improves the model training efficiency, improves the accuracy of the trained super-resolution model and the trained recognition model, and has a wider range of applications.

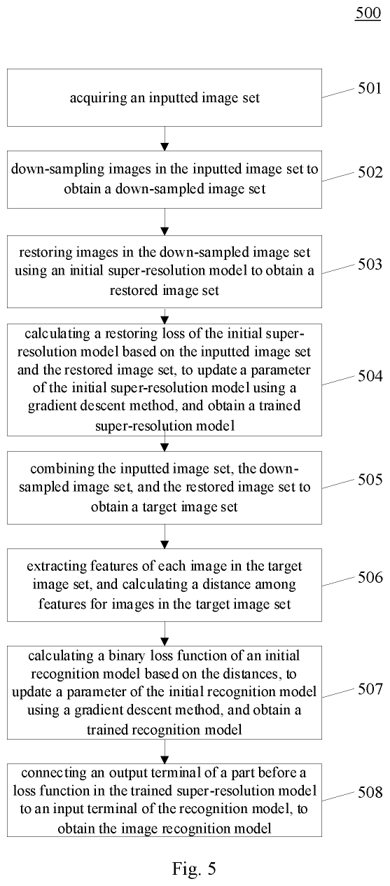

Further referring to FIG. 5, FIG. 5 shows a process 500 of the method for establishing an image recognition model according to still another embodiment of the present disclosure. The method for establishing an image recognition model includes the following steps.

Step 501: acquiring an inputted image set.

Step 501 is substantially consistent with step 401 in the above embodiments, and the above description of step 401 may be referred to for specific implementations of this step. The description will not be repeated here.

Step 502: down-sampling images in the inputted image set to obtain a down-sampled image set.

In the present embodiment, an executing body (e.g., the server 105 shown in FIG. 1) of the method for establishing an image recognition model may down-sample each image in the inputted image set, thereby obtaining a corresponding down-sampled image, and then obtain a down-sampled image set including down-sampled images each corresponding to an inputted image in the inputted image set. The down-sampled image obtained in this step is a low-quality image that is more in line with an actual application scenario.

Step 503: restoring images in the down-sampled image set using an initial super-resolution model to obtain a restored image set.

In the present embodiment, the executing body may restore each down-sampled image in the down-sampled image set using the initial super-resolution model, thereby obtaining a corresponding restored image, where the restored image is a high-quality image obtained by restoring a low-quality image obtained in step 502, and then obtaining the restored image set including the restored images each corresponding to a down-sampled image in the down-sampled image set.

Step 504: calculating a restoring loss of the initial super-resolution model based on the inputted image set and the restored image set, to update a parameter of the initial super-resolution model using a gradient descent method, and obtain a trained super-resolution model.

In the present embodiment, the executing body may calculate the restoring loss using inputted images in the inputted image set and restored images, each corresponding to an inputted image, in the restored image set, use the gradient descent method to obtain a solution through iteration step by step, thereby obtaining a minimized loss function and a model parameter value, and then update the parameter of the initial super-resolution model based on the obtained model parameter value, thereby obtaining the trained super-resolution model.

By the above steps, the result quality of the super-resolution model is improved.

Step 505: combining the inputted image set, the down-sampled image set, and the restored image set to obtain a target image set.

In the present embodiment, the executing body may combine the inputted image set, the down-sampled image set, and the restored image set to obtain the target image set.

Step 506: extracting features of each image in the target image set, and calculating a distance among features for images in the target image set.

In the present embodiment, the executing body may extract features of each image in the target image set, and calculate a distance among the features for the images in the target image set based on the extracted features.

Optionally, before acquiring the inputted image set, inputted images in the inputted image set may be annotated, and an ID (Identity number) may be assigned to each target object. The target object is an object represented by a face in the inputted images. Then an inputted image corresponding to each target object in the inputted image set should have the same ID, and each of an ID of the down-sampled image and an ID of the restored image corresponds to the ID of the inputted image.

Based on this, in this step, a distance among the images may be calculated based on the IDs, a distance among images with the same ID may be calculated based on the extracted features, and then a distance among images with different IDs may be calculated.

Step 507: calculating a binary loss function of an initial recognition model based on the distances, to update a parameter of the initial recognition model using a gradient descent method, and obtain a trained recognition model.

In the present embodiment, the executing body may calculate the binary loss function of the initial recognition model based on the distances calculated in step 506.

Optionally, when two images have an identical ID, the loss function in this case is a square of a distance between the two images. When two images have different IDs, a margin between the two images will be first calculated, and then a max of distances for images with different IDs will be calculated, to obtain a loss value in this case. That is, the distance between two images with an identical ID is smaller, while a distance between two images with different IDs is greater, thereby increasing an inter-class difference and decreasing an intra-class difference.

Then, the executing body uses the gradient descent method to obtain a solution through iteration step by step, thereby obtaining the minimized loss function and the model parameter value, and then update the parameter of the initial recognition model using the obtained model parameter value, thereby obtaining the trained recognition model.

The above steps improve the categorization accuracy of the recognition model.

Step 508: connecting an output terminal of a part before a loss function in the trained super-resolution model to an input terminal of the recognition model, to obtain the image recognition model.

Step 508 is substantially consistent with step 404 in the above embodiments, and the above description of step 404 may be referred to for specific implementations of this step. The description will not be repeated here.

As can be seen from FIG. 5, compared with the corresponding embodiment of FIG. 4, the method for establishing an image recognition model in the present embodiment calculates the restoring loss of an initial super-resolution model based on an inputted image set and a restored image set, and a binary loss function of an initial recognition model, and updates a parameter of the initial super-resolution model and a parameter of the initial recognition model using a gradient descent method, to obtain a trained super-resolution model and a trained recognition model, thereby improving the result quality of the super-resolution model and the categorization accuracy of the recognition model.

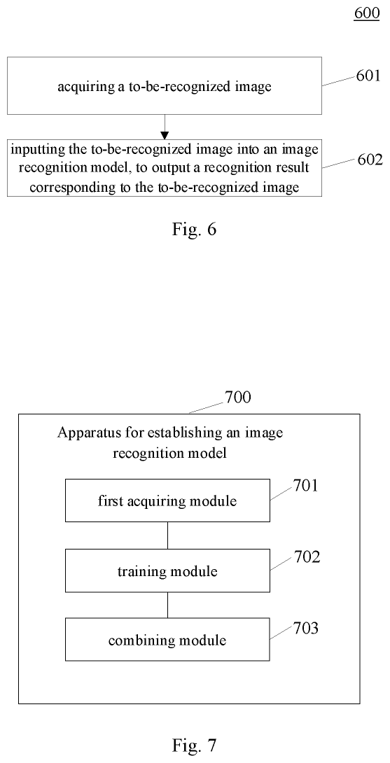

Further referring to FIG. 6, FIG. 6 shows a process 600 of an image recognition method according to an embodiment of the present disclosure. The image recognition method includes the following steps.

Step 601: acquiring a to-be-recognized image.

In the present embodiment, an executing body (e.g., the server 105 shown in FIG. 1) of the image recognition method may acquire the to-be-recognized image, where the to-be-recognized image may be an image including a face and collected by a camera sensor in an actual application scenario of face recognition.

Step 602: inputting the to-be-recognized image into an image recognition model, to output a recognition result corresponding to the to-be-recognized image.

In the present embodiment, the executing body may input the to-be-recognized image into the image recognition model to output the recognition result corresponding to the to-be-recognized image, where the image recognition model may be obtained using the method for establishing an image recognition model in the above embodiments.

After the executing body inputs the to-be-recognized image into the image recognition model, the image recognition model will first restore the to-be-recognized image to obtain a corresponding restored image; then extract a feature of the to-be-recognized image and a feature of the restored image, classify the to-be-recognized image based on the feature of the to-be-recognized image, and classify the restored image based on the feature of the restored image, thereby obtaining a corresponding recognition result, and outputting the recognition result.

The image recognition method provided in the embodiment of the present disclosure first acquires a to-be-recognized image; and then inputs the to-be-recognized image into an image recognition model, to output a recognition result corresponding to the to-be-recognized image. The image recognition method in the present embodiment recognizes the to-be-recognized image using a pre-trained image recognition model, thereby improving the accuracy of the recognition result.

Further referring to FIG. 7, as an implementation of the method shown in the above figures, an embodiment of the present disclosure provides an apparatus for establishing an image recognition model. The embodiment of the apparatus corresponds to the embodiment of the method shown in FIG. 2, and the apparatus may be specifically applied to various electronic devices.

As shown in FIG. 7, the apparatus 700 for establishing an image recognition model of the present embodiment includes: a first acquiring module 701, a training module 702, and a combining module 703. The first acquiring module 701 is configured to acquire an inputted image set; the training module 702 is configured to perform co-training on an initial super-resolution model and an initial recognition model using the inputted image set, to obtain a trained super-resolution model and a trained recognition model; and the combining module 703 is configured to combine the trained super-resolution model and the trained recognition model in a cascaded manner to obtain the image recognition model.

The related description of steps 201 to 203 in the corresponding embodiment of FIG. 2 may be referred to for specific processing of the first acquiring module 701, the training module 702, and the combining module 703 of the apparatus 700 for establishing an image recognition model in the present embodiment and the technical effects thereof, respectively. The description will not be repeated here.

In some optional implementations of the present embodiment, the training module includes: a first updating submodule configured to calculate a loss function of the initial super-resolution model using the inputted image set and a restored image set corresponding to the inputted image set, to update a parameter of the initial super-resolution model using a gradient descent method; and a second updating submodule configured to calculate a loss function of the initial recognition model based on a distance among features for images in the inputted image set and in the restored image set, to update a parameter of the initial recognition model using a gradient descent method.

In some optional implementations of the present embodiment, the first updating submodule includes: a down-sampling unit configured to down-sample images in the inputted image set to obtain a down-sampled image set; a restoring unit configured to restore images in the down-sampled image set using the initial super-resolution model to obtain the restored image set; and a first calculating unit configured to calculate a restoring loss of the initial super-resolution model based on the inputted image set and the restored image set.

In some optional implementations of the present embodiment, the second updating submodule includes: a combining unit configured to combine the inputted image set, the down-sampled image set, and the restored image set to obtain a target image set; an extracting unit configured to extract image features in the target image set; a second calculating unit configured to calculate a distance among the image features for images in the target image set; and a third calculating unit configured to calculate a binary loss function of the initial recognition model based on the distance.

In some optional implementations of the present embodiment, the combining module includes: a connecting submodule configured to connect an output terminal of a part before the loss function in the trained super-resolution model to an input terminal of the recognition model.

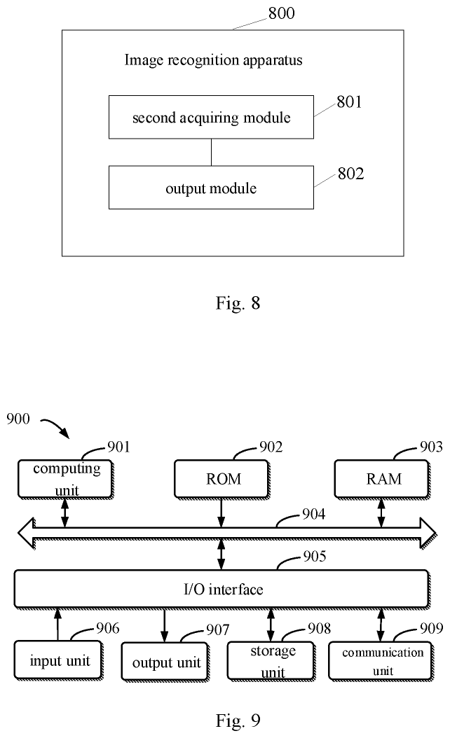

Further referring to FIG. 8, as an implementation of the method shown in the above figures, an embodiment of the present disclosure provides an image recognition apparatus. The embodiment of the apparatus corresponds to the embodiment of the method shown in FIG. 6, and the apparatus may be specifically applied to various electronic devices.

As shown in FIG. 8, the image recognition apparatus 800 of the present embodiment includes: a second acquiring module 801, an output module 802. The second acquiring module 801 is configured to acquire a to-be-recognized image; and the output module 802 is configured to input the to-be-recognized image into an image recognition model to output a recognition result corresponding to the to-be-recognized image.

The related description of steps 601 to 602 in the corresponding embodiment of FIG. 6 may be referred to for specific processing of the second acquiring module 801 and the output module 802 of the apparatus 800 for image recognition in the present embodiment and the technical effects thereof, respectively. The description will not be repeated here.

According to an embodiment of the present disclosure, the present disclosure further provides an electronic device, a readable storage medium, and a computer program product.

FIG. 9 shows a schematic block diagram of an example electronic device 900 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 9, the device 900 includes a computing unit 901, which may execute various appropriate actions and processes in accordance with a computer program stored in a read-only memory (ROM) 902 or a computer program loaded into a random-access memory (RAM) 903 from a storage unit 908. The RAM 903 may further store various programs and data required by operations of the device 900. The computing unit 901, the ROM 902, and the RAM 903 are connected to each other through a bus 904. An input/output (I/O) interface 905 is also connected to the bus 904.

A plurality of components in the device 900 is connected to the I/O interface 905, including: an input unit 906, such as a keyboard and a mouse; an output unit 907, such as various types of displays and speakers; a storage unit 908, such as a magnetic disk and an optical disk; and a communication unit 909, such as a network card, a modem, and a wireless communication transceiver. The communication unit 909 allows the device 900 to exchange information/data with other devices via a computer network such as the Internet and/or various telecommunication networks.

The computing unit 901 may be various general-purpose and/or special-purpose processing components having a processing power and a computing power. Some examples of the computing unit 901 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. The computing unit 901 executes various methods and processes described above, such as a method for establishing an image recognition model or an image recognition method. For example, in some embodiments, the method for establishing an image recognition model or the image recognition method may be implemented as a computer software program that is tangibly included in a machine-readable medium, such as the storage unit 908. In some embodiments, some or all of the computer programs may be loaded and/or installed onto the device 900 via the ROM 902 and/or the communication unit 909. When the computer programs are loaded into the RAM 903 and are executed by the computing unit 901, one or more steps of the method for establishing an image recognition model or the image recognition method described above may be executed. Alternatively, in other embodiments, the computing unit 901 may be configured to execute the method for establishing an image recognition model or the image recognition method by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output apparatus.

Program codes for implementing the method of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flowcharts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solution disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for establishing an image recognition model, comprising:
acquiring an inputted image set;
performing co-training on an initial super-resolution model and an initial recognition model using the inputted image set, to obtain a trained super-resolution model and a trained recognition model; and
combining the trained super-resolution model and the trained recognition model in a cascaded manner to obtain the image recognition model.

2. The method according to claim 1, wherein performing co-training on the initial super-resolution model and the initial recognition model using the inputted image set comprises:
calculating a loss function of the initial super-resolution model using the inputted image set and a restored image set corresponding to the inputted image set, to update a parameter of the initial super-resolution model using a gradient descent method; and
calculating a loss function of the initial recognition model based on a distance among features for images in the inputted image set and in the restored image set, to update a parameter of the initial recognition model using a gradient descent method.

3. The method according to claim 2, wherein calculating the loss function of the initial super-resolution model using the inputted image set and the restored image set corresponding to the inputted image set comprises:
down-sampling images in the inputted image set to obtain a down-sampled image set;
restoring images in the down-sampled image set using the initial super-resolution model to obtain the restored image set; and
calculating a restoring loss of the initial super-resolution model based on the inputted image set and the restored image set.

4. The method according to claim 3, wherein calculating the loss function of the initial recognition model based on the distance among features for images in the inputted image set and in the restored image set comprises:
combining the inputted image set, the down-sampled image set, and the restored image set to obtain a target image set;
extracting image features in the target image set;
calculating a distance among the image features for images in the target image set; and
calculating a binary loss function of the initial recognition model based on the distance.

5. The method according to claim 2, wherein the gradient descent method is a stochastic gradient descent method.

6. The method according to claim 1, wherein combining the trained super-resolution model and the trained recognition model in the cascaded manner comprises:
connecting an output terminal of a part before a loss function in the trained super-resolution model to an input terminal of the recognition model.

7. An image recognition method, comprising:
acquiring a to-be-recognized image; and
inputting the to-be-recognized image into an image recognition model to output a recognition result corresponding to the to-be-recognized image, wherein the image recognition model is obtained using the method for establishing an image recognition model according to claim 1.

8. An apparatus for establishing an image recognition model, comprising:
at least one processor; and
a memory storing instructions, wherein the instructions when executed by the at least one processor, cause the at least one processor to perform operations, the operations comprising:
acquiring an inputted image set;
performing co-training on an initial super-resolution model and an initial recognition model using the inputted image set, to obtain a trained super-resolution model and a trained recognition model; and
combining the trained super-resolution model and the trained recognition model in a cascaded manner to obtain the image recognition model.

9. The apparatus according to claim 8, wherein performing co-training on the initial super-resolution model and the initial recognition model using the inputted image set comprises:
calculating a loss function of the initial super-resolution model using the inputted image set and a restored image set corresponding to the inputted image set, to update a parameter of the initial super-resolution model using a gradient descent method; and
calculating a loss function of the initial recognition model based on a distance among features for images in the inputted image set and in the restored image set, to update a parameter of the initial recognition model using a gradient descent method.

10. The apparatus according to claim 9, wherein calculating the loss function of the initial super-resolution model using the inputted image set and the restored image set corresponding to the inputted image set comprises:
down-sampling images in the inputted image set to obtain a down-sampled image set;
restoring images in the down-sampled image set using the initial super-resolution model to obtain the restored image set; and
calculating a restoring loss of the initial super-resolution model based on the inputted image set and the restored image set.

11. The apparatus according to claim 10, wherein calculating the loss function of the initial recognition model based on the distance among features for images in the inputted image set and in the restored image set comprises:
combining the inputted image set, the down-sampled image set, and the restored image set to obtain a target image set;
extracting image features in the target image set;
calculating a distance among the image features for images in the target image set; and
calculating a binary loss function of the initial recognition model based on the distance.

12. The apparatus according to claim 8, wherein combining the trained super-resolution model and the trained recognition model in the cascaded manner comprises:
connecting an output terminal of a part before a loss function in the trained super-resolution model to an input terminal of the recognition model.

13. An image recognition apparatus, comprising:
at least one processor; and
a memory storing instructions, wherein the instructions when executed by the at least one processor, cause the at least one processor to perform operations, the operations comprising:
acquiring a to-be-recognized image; and
inputting the to-be-recognized image into an image recognition model to output a recognition result corresponding to the to-be-recognized image, wherein the image recognition model is obtained using the method for establishing an image recognition model according to claim 1.

14. A non-transitory computer readable storage medium storing computer instructions, wherein the computer instructions are used for causing the computer to execute operations comprising:
acquiring an inputted image set;
performing co-training on an initial super-resolution model and an initial recognition model using the inputted image set, to obtain a trained super-resolution model and a trained recognition model; and
combining the trained super-resolution model and the trained recognition model in a cascaded manner to obtain the image recognition model.

15. The non-transitory computer readable storage medium according to claim 14, wherein performing co-training on the initial super-resolution model and the initial recognition model using the inputted image set comprises:
calculating a loss function of the initial super-resolution model using the inputted image set and a restored image set corresponding to the inputted image set, to update a parameter of the initial super-resolution model using a gradient descent method; and
calculating a loss function of the initial recognition model based on a distance among features for images in the inputted image set and in the restored image set, to update a parameter of the initial recognition model using a gradient descent method.

16. The non-transitory computer readable storage medium according to claim 15, wherein calculating the loss function of the initial super-resolution model using the inputted image set and the restored image set corresponding to the inputted image set comprises:
down-sampling images in the inputted image set to obtain a down-sampled image set;
restoring images in the down-sampled image set using the initial super-resolution model to obtain the restored image set; and
calculating a restoring loss of the initial super-resolution model based on the inputted image set and the restored image set.

17. The non-transitory computer readable storage medium according to claim 16, wherein calculating the loss function of the initial recognition model based on the distance among features for images in the inputted image set and in the restored image set comprises:
combining the inputted image set, the down-sampled image set, and the restored image set to obtain a target image set;
extracting image features in the target image set;
calculating a distance among the image features for images in the target image set; and
calculating a binary loss function of the initial recognition model based on the distance.

18. The non-transitory computer readable storage medium according to claim 15, wherein the gradient descent method is a stochastic gradient descent method.

19. The non-transitory computer readable storage medium according to claim 14, wherein combining the trained super-resolution model and the trained recognition model in the cascaded manner comprises:
connecting an output terminal of a part before a loss function in the trained super-resolution model to an input terminal of the recognition model.
